(19) United States
(12) Patent Application Publication
(10) Pub. No.: US 2025/0345243 A1
(43) Pub. Date: Nov. 13, 2025

(54) HANDS-FREE MEDICAL VIAL STABILIZATION DEVICE

(71) Applicant: PMI Practical Medical Innovations, LLC, Bath, SD (US)

(72) Inventors: Jacob Miller, Bath, SD (US); Lynette Tarnowski, Aberdeen, SD (US)

(21) Appl. No.: 19/201,296

(22) Filed: May 7, 2025

Related U.S. Application Data
(60) Provisional application No. 63/643,578, filed on May 7, 2024.

(51) Int. Cl. A61J 1/16

(52) U.S. Cl. CPC A61J 1/16

(57) ABSTRACT

A device for holding a plurality of medical containers includes a clamp and a faceplate having a container opening configured to receive a container and a slidable adjustment panel within the container opening. The adjustment panel is positionable between an open position whereby a container may be received within or removed from the container opening, and a closed position whereby a container may be securely held in place in the container opening. The device further includes an adjustment assembly fixable to the clamp and to the faceplate. The adjustment assembly includes a first component fixable to the faceplate and a second component fixable to the clamp. The first component and the second component are rotationally positionable with respect to one another.

### CROSS-REFERENCE TO RELATED APPLICATION(S)

This application claims the benefit under 35 U.S.C. § 199(e) to U.S. Provisional Application 63/643,578, filed May 7, 2024 and entitled “Hands-Free Medical Vial Stabilization Device,” the contents of which is hereby incorporated by reference in its entirety.

### FIELD

The various embodiments herein relate to devices for use during medical procedures, including devices for holding and stabilizing medical vials.

### BACKGROUND

Medicine, often stored in vials, may be need to be accessed by medical personnel during various medical procedures. This can result in two medical personnel working to extract various medicines from their vials. Typically, one staff member manipulates the medical vial while another staff member extracts medicine from within. This two-person approach can be implemented while aspirating medication as well.

Such known methods of holding medical vials and aspirating medication can increase the time needed to prepare medication for various procedures. Further, these methods require the use of multiple personnel that would otherwise partake in other tasks during this time. Such methods also introduce a risk of inadvertent needle sticks while aspirating medications.

### BRIEF SUMMARY

Discussed herein are various devices and methods for securely holding in advantageous positions medical vials and other medical containers for easy access to a practitioner.

In Example 1, a device for holding a plurality of medical containers includes a clamp and a faceplate having a container opening configured to receive a container and a slidable adjustment panel within the container opening. The adjustment panel is positionable between an open position whereby a container may be received within or removed from the container opening, and a closed position whereby a container may be securely held in place in the container opening. The device further includes an adjustment assembly fixable to the clamp and to the faceplate. The adjustment assembly includes a first component fixable to the faceplate and a second component fixable to the clamp. The first component and the second component are rotationally positionable with respect to one another.

Example 2 relates to the device according to Example 1, wherein the faceplate further comprises a spring operably coupled to the at least one adjustment panel, the spring configured to urge the adjustment panel toward the closed position.

Example 3 relates to the device according to Example 1, wherein the at least one adjustment panel further comprises a positioning flange extending through an adjustment opening in the faceplate such that a user is able to adjust the adjustment panels to increase the opening within each of the securing holes.

Example 4 relates to the device according to Example 1, wherein the at least one container opening comprises at least four openings.

Example 5 relates to the device according to Example 1, wherein the container is a vial containing medical liquid.

Example 6 relates to the device according to Example 1, wherein the adjustment assembly further comprises a tightening bolt, and wherein first component and the second component each comprises corresponding teeth that are selectively operably coupled by the tightening bolt.

Example 7 relates to the device according to Example 1, wherein the first and second components further comprise locking mechanisms.

Example 8 relates to the device according to Example 7, wherein the locking mechanisms of the first and second components are in a locked position by default.

Example 9 relates to the device according to Example 8, wherein a user activates an unlock mechanism on at least one of the first and second components to re-orient the faceplate.

Example 10 relates to the device according to Example 1, wherein the unlock mechanism is a button that a user depresses.

Example 11 relates to the device according to Example 1, wherein the clamp comprises a base, a holding flange, and a locking mechanism.

In Example 12 a device for securely holding medicinal containers comprises a base having a container opening configured to receive a container therewithin, an adjustment opening, and an adjustment panel slidably disposed within the container opening and having an adjustment flange on an end opposite from the container opening and extending through the at least one adjustment opening. The adjustment panel is positionable between an open position whereby a container may be received within or removed from the at least one container opening and a closed position whereby a container may be securely held in place. The device further comprises a clamp operably coupled to the base and configured to securely attach to a surface.

Example 13 relates to the device according to Example 12, and further comprises an adjustment assembly fixable to the clamp on a proximal portion and fixable to the faceplate on a distal portion. The adjustment assembly comprises a first component fixable to the faceplate and a second component fixable to the clamp. The first component and the second component are rotationally positionable with respect to one another.

Example 14 relates to the device according to Example 13, wherein the adjustment assembly further comprises a tightening bolt, and wherein first component and the second component each comprises corresponding teeth that are selectively operably coupled by the tightening bolt.

Example 15 relates to the device according to Example 12, wherein the at least one container opening comprises at least three openings.

Example 16 relates to the device according to Example 12, wherein the at least one adjustment panel further comprises a positioning flange extending through an adjustment opening in the faceplate such that a user is able to adjust the adjustment panels to increase the opening within each of the securing holes.

Example 17 relates to the device according to Example 12, wherein the clamp is operably coupled to the base on a side opposite from the at least one container opening.

In Example 18 a device for holding a plurality of containers comprises a clamp configured to operably couple to a surface and a faceplate having a container opening configured to receive a container therewithin, at least one adjustment opening, and an adjustment panel slidably disposed within the container opening and having an adjustment flange on an end opposite from the container opening and extending through the at least one adjustment opening. The adjustment panel is positionable between an open position whereby a container may be received within or removed from the at least one container opening, and a closed position whereby a container may be securely held in place. The device further comprises an adjustment assembly fixable to the clamp on a proximal portion and fixable to the faceplate on a distal portion. The adjustment assembly comprises a first component fixable to the faceplate, and a second component fixable to the clamp. The first component and the second component are rotationally positionable and lockable with respect to one another.

Example 19 relates to the device according to Example 18, wherein the adjustment assembly further comprises a tightening bolt, and wherein first component and the second component each comprises corresponding teeth that are selectively operably coupled by the tightening bolt.

Example 20 relates to the device according to Example 18, wherein the faceplate further comprises a spring operably coupled to the at least one adjustment panel, the spring configured to urge the adjustment panel toward the closed position.

While multiple embodiments are disclosed, still other embodiments will become apparent to those skilled in the art from the following detailed description, which shows and describes various illustrative implementations. As will be realized, the various embodiments herein are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

The following drawings are illustrative of particular examples of the present invention and therefore do not limit the scope of the invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1A is a perspective view of two embodiments of a medical vial stabilization device, in accordance with the systems and techniques described herein.

FIG. 1B is a perspective view of an embodiment of a medical vial stabilization device, in accordance with the systems and techniques described herein.

FIG. 2A is a perspective view of an embodiment of a medical vial stabilization device, in accordance with the systems and techniques described herein.

FIG. 2B is another perspective view of an embodiment of a medical vial stabilization device, in accordance with the systems and techniques described herein.

FIG. 2C is a perspective view of an embodiment of a clamp and adjustability mechanism of a medical vial stabilization device, in accordance with the systems and techniques described herein.

FIG. 2D is another perspective view of an embodiment of a clamp and adjustability mechanism of a medical vial stabilization device, in accordance with the systems and techniques described herein.

FIG. 2E is a perspective view of an embodiment of a faceplate assembly of a medical vial stabilization device, in accordance with the systems and techniques described herein.

FIG. 2F is a perspective view of an embodiment of a faceplate assembly of a medical vial stabilization device, in accordance with the systems and techniques described herein.

FIG. 2G is a bottom view of an embodiment of a faceplate assembly of a medical vial stabilization device, in accordance with the systems and techniques described herein.

FIG. 2H is a top view of an embodiment of a faceplate assembly of a medical vial stabilization device, in accordance with the systems and techniques described herein.

FIG. 2I is a front view of an embodiment of faceplate assembly of a medical vial stabilization device, in accordance with the systems and techniques described herein.

FIG. 2J is a rear view of an embodiment of a faceplate assembly of a medical vial stabilization device, in accordance with the systems and techniques described herein.

FIG. 3A is a perspective view of another embodiment of a medical vial stabilization device, in accordance with the systems and techniques described herein.

FIG. 3B is a perspective view of an embodiment of a faceplate assembly of a medical vial stabilization device, in accordance with the systems and techniques described herein.

FIG. 3C is a perspective view of an embodiment of a faceplate assembly of a medical vial stabilization device, in accordance with the systems and techniques described herein.

FIG. 3D is a perspective view of an embodiment of a T-bar of a medical vial stabilization device, in accordance with the systems and techniques described herein.

FIG. 3E is a perspective view of an embodiment of a rotation beam of a medical vial stabilization device, in accordance with the systems and techniques described herein.

FIG. 3F is a perspective view of an embodiment of the connection of a rotation beam to a clamp of a medical vial stabilization device, in accordance with the systems and techniques described herein.

FIG. 3G is another perspective view of an embodiment of the connection of a rotation beam to a clamp of a medical vial stabilization device, in accordance with the systems and techniques described herein.

FIG. 3H is top view of an embodiment of the connection of a rotation beam to a clamp of a medical vial stabilization device, in accordance with the systems and techniques described herein.

### DETAILED DESCRIPTION

The various embodiments herein relate to devices for holding and/or stabilizing vials. In particular, the embodiments herein can be used to hold and/or stabilize vials used in medical procedures.

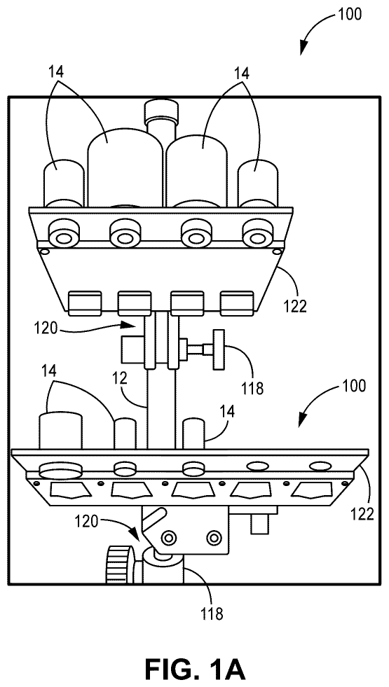

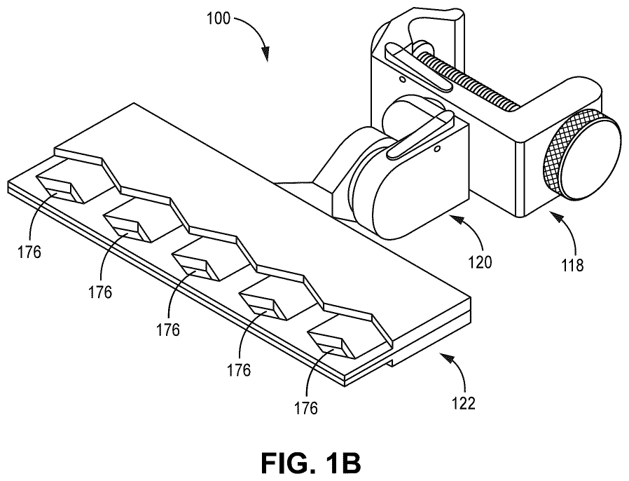

FIG. 1 shows an embodiment of a hands-free medical vial stabilization device 100. In some embodiments, the device 100 may include a clamp 118, an adjustability mechanism 120, and a faceplate assembly 122. The faceplate assembly 122 may include a plurality of adjustable holes or openings 176 configured to receive medical containers 14 (e.g., vials of liquid medical substances). The clamp 118 may be coupled to the faceplate assembly 122 opposite the openings 176 (i.e., the openings 176 may be on a front side of the faceplate assembly for ease of use by the practitioner, while the clamp 118 is coupled to the back side of the faceplate assembly 122) through an adjustability mechanism 120 which allows for the faceplate assembly to be easily adjusted or maneuvered for ease of use by the practitioner with respect to the clamp 118 which is affixed to a surface 12 as described in detail below.

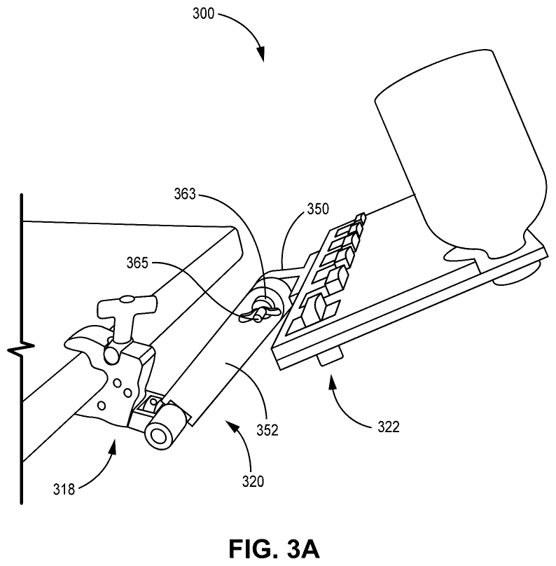

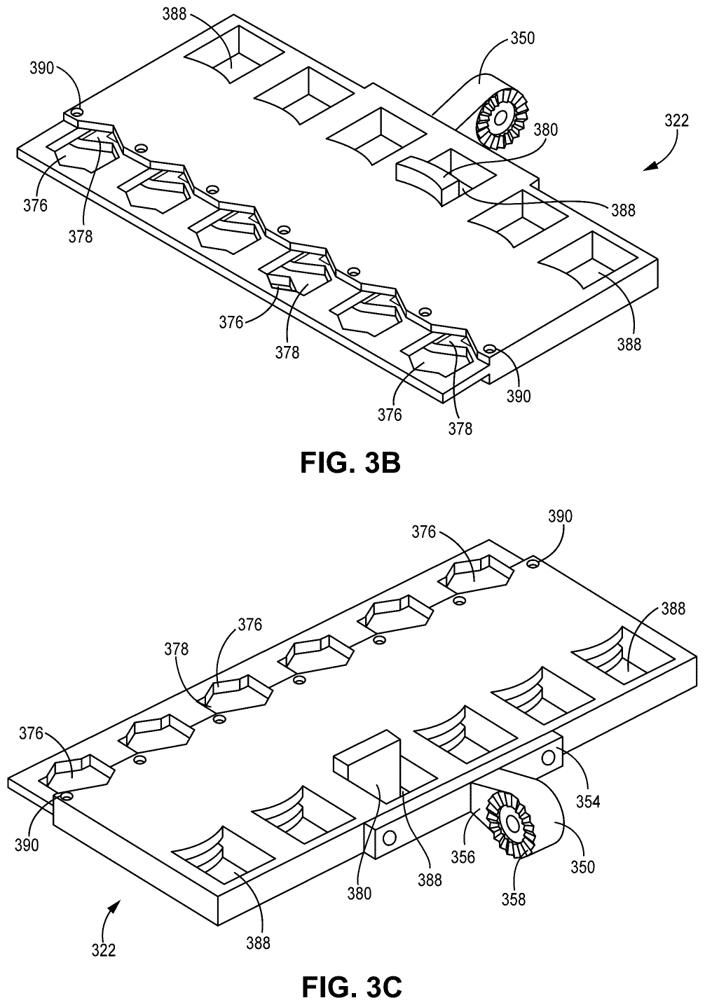

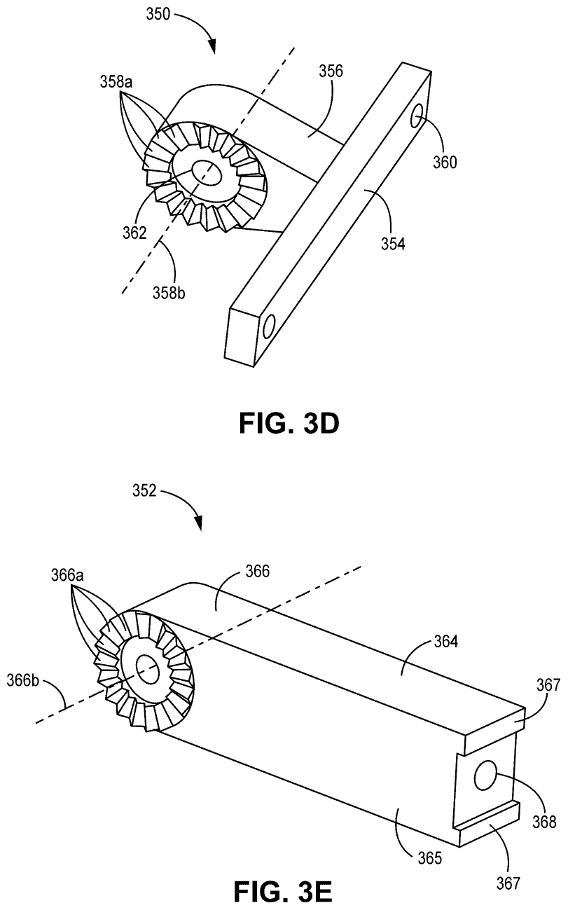

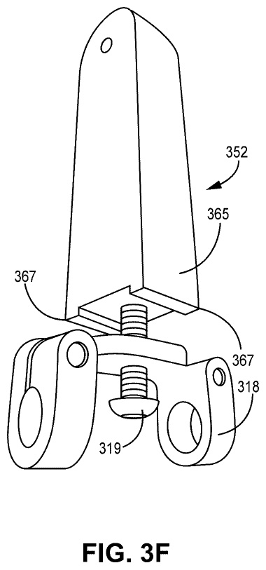

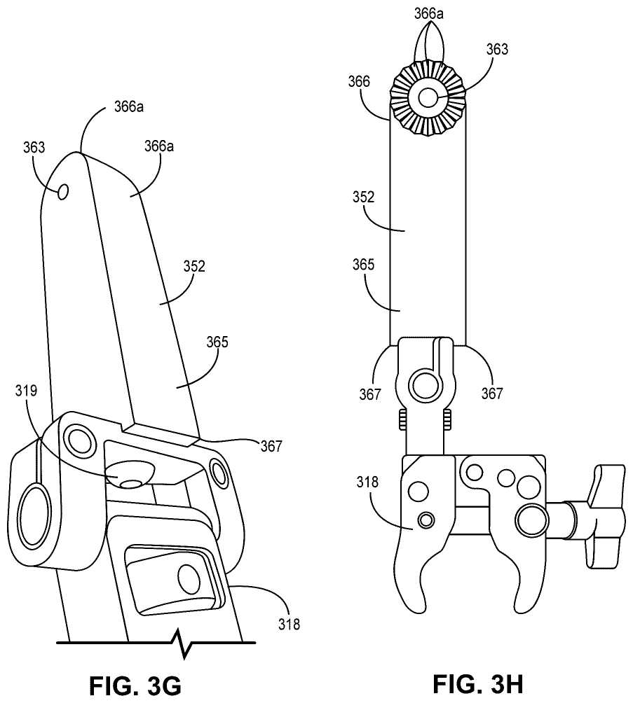

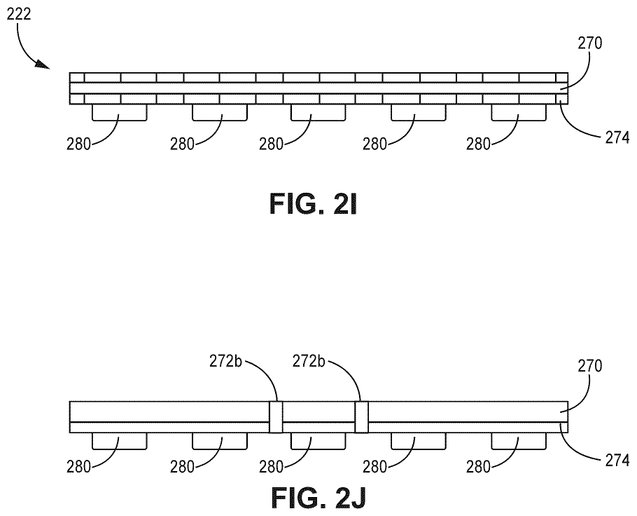

The stabilization device 100 can be mounted on a surface 12 (e.g., a pole as shown in FIG. 1, a table as best shown in FIG. 3A, a shelf, a bed headboard, and/or any other stable surface or object in the procedural space) and can hold at least one container or vial 14 when in use. In particular, this can be used to hold and/or stabilize the containers 14 during medical procedures, typically in an upside-down position as best shown in FIG. 1A, although it should be known that the containers 14 may be in any orientation advantageous to the practitioner.

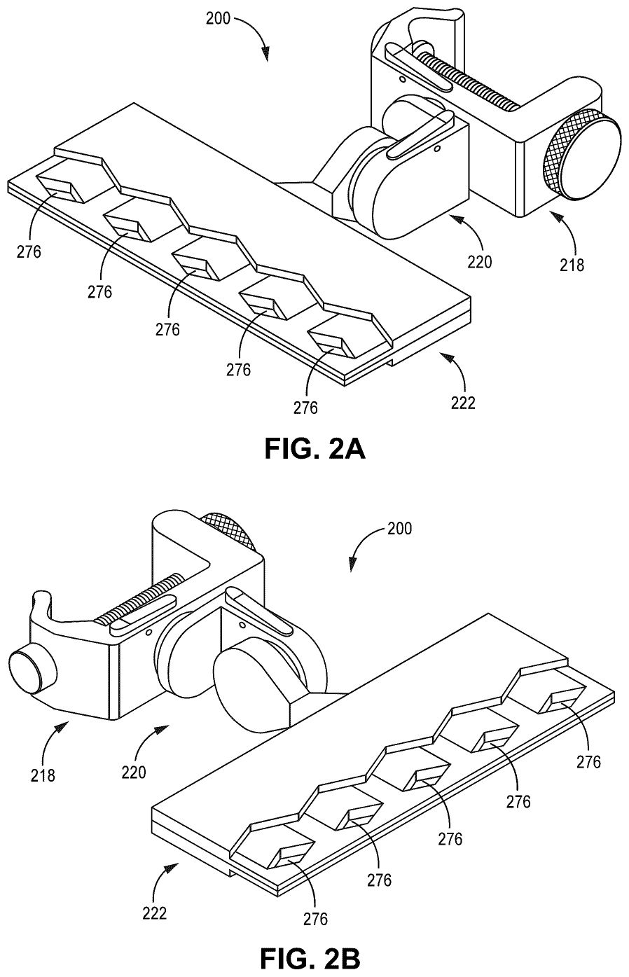

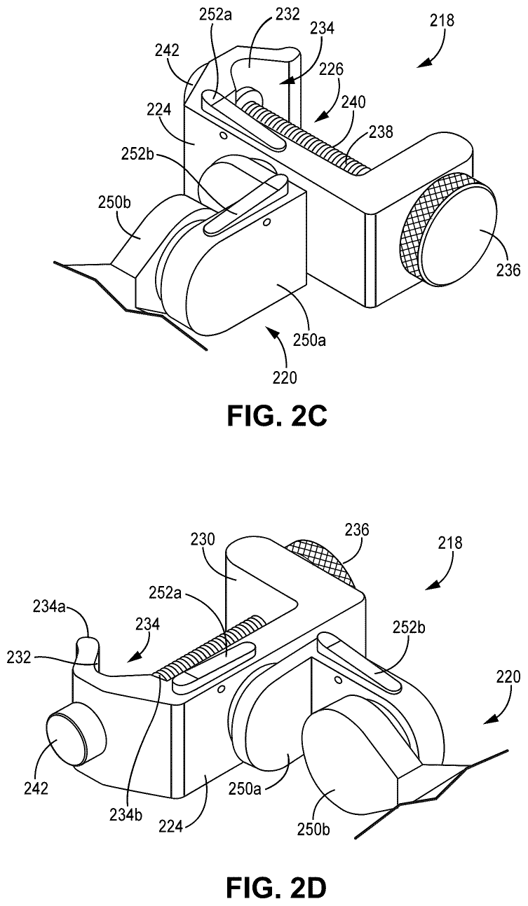

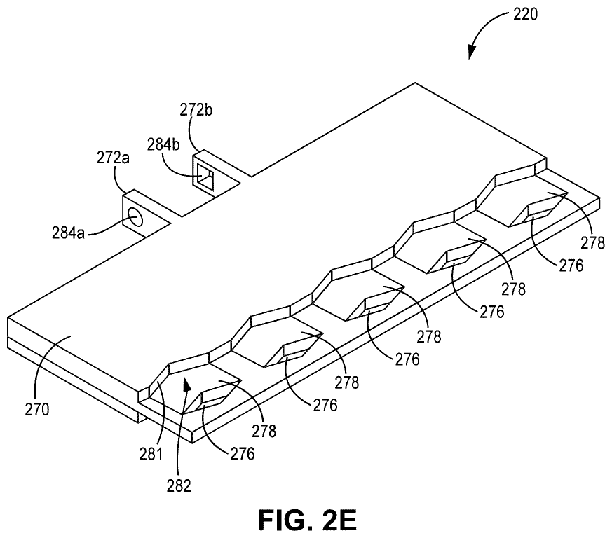

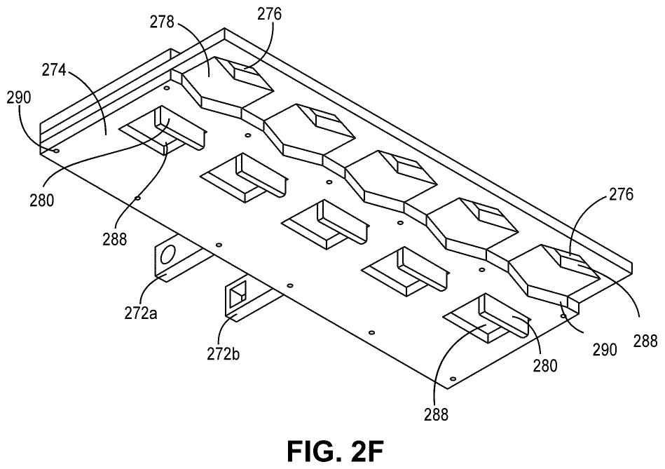

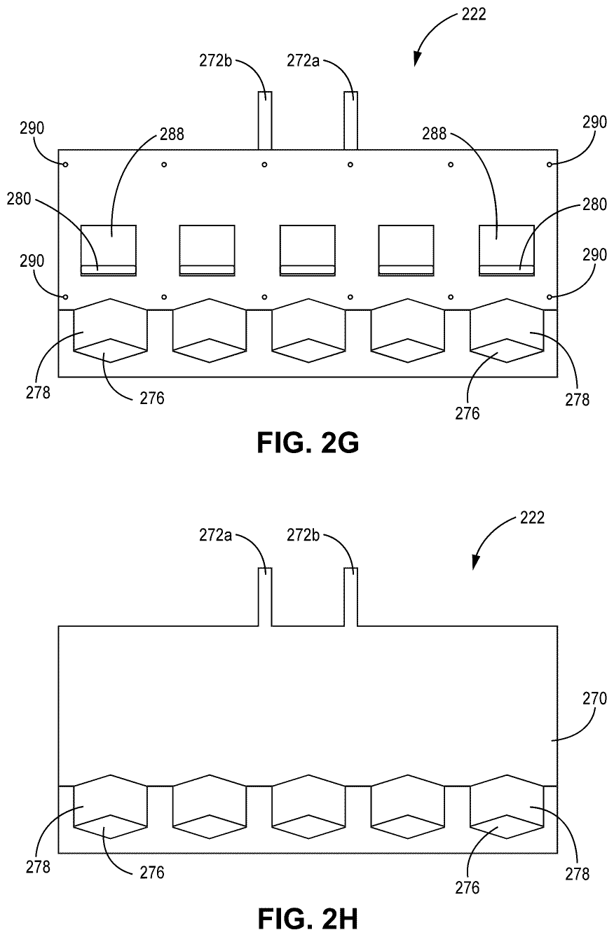

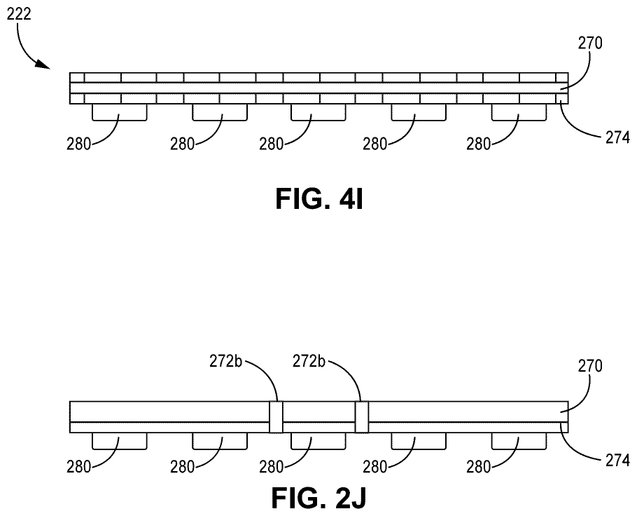

As best shown in FIGS. 2A-2B, in some embodiments, a device 200 may be substantially similar to the device 100 from FIGS. 1A-1B except as described below. In such embodiments, the device 200 may hold and/or stabilize containers 14 of varying sizes using at least one adjustable opening 276 on or within a faceplate assembly 222 as detailed below. In some embodiments the device 200 is capable of holding up to five vials 14, although it should be known that the device 200 may be configured to hold any number of containers 14 (e.g., 1, 2, 3, 4, 6, or more containers) and in any configuration (e.g., in a line as shown in FIGS. 2A-2B, in a stacked formation, in a circular formation, or in any other formation) without deviating from the scope of the disclosure. When the stabilization device 200 is mounted on a surface 12 via the clamp 218, the device 200 may be manipulated such that the faceplate 222 and the containers 14 held thereon can be disposed at various angles and/or configurations to provide easy access for a practitioner. This allows a user to attach the device 200 at various locations and to various surfaces, including, but not limited to, surfaces found in clinics, procedural rooms, and/or carts.

As best shown in FIGS. 2C-2D, the device 200 can be mounted on a surface 12 in a variety of ways. In some embodiments, the device 200 can be mounted to a surface having any orientation (e.g., a pole oriented vertically, a flat surface oriented horizontally, or any other orientation) using the clamp 218. As shown, the clamp may include a C-bracket 224 and a tightening screw 226. The clamp 218 may be configured to attach to any surface 12 to which the clamp 218 may be tightened.

The C-bracket 224 of the clamp 218 may include a base face 230, a connection face 232, and a channel 234. In some embodiments, the base face 230 may include one or more threaded openings (not explicitly shown in the figures). The threaded opening(s) may be configured to receive a tightening screw 226 therethrough. In some embodiments, The connection face 232 may be disposed adjacent to or against a surface (not pictured) when the device 200 is in use. In some embodiments, the connection face 232 may be in contact with at least a portion of the surface 12.

The channel 234 may include a variety of characteristics configured to affix the device 200 to a variety of various surfaces 12. In some embodiments, the channel 234 may be a U-shaped channel 234 including a U-face surface 232 and ends 234a, 234b. The U-shaped surface 232 may be sized and shaped to accommodate any surface to which the device 200 is to be attached. In some embodiments, this surface 12 may be a pole, as best shown in FIG. 1, although it should be known that the surface 12 may be any surface that is available to a practitioner to affix the device 200. The U-shaped surface 232 may have a curvature configured to accommodate a rod, pole, or other circular surface having varying diameters. The ends 234a, 234b may be aligned along a plane such that the clamp 218 may be affixed to a planar surface 12 such as a shelf or a table. However, these are merely exemplary embodiments of such a channel. In other embodiments, the channel 234 may be any shape, size, or configuration to accommodate any stable surface available to a practitioner.

In some embodiments, the C-bracket 224 may be used in combination with a tightening screw 226. The tightening screw 226 may include a variety of features. For example, in some embodiments, the tightening screw may include a handle 236, a rod 238, and external threads 240. The external threads 240 of the screw may be configured to threadably couple to the internal threads (not pictured) of the base face 230.

In some embodiments, the clamp 218 includes a handle 236 coupled to the tightening screw 226. The handle 236 may have variety of features. For example, the handle 236 of the screw 226 may have a handle diameter, and the rod 238 of the screw 226 may have a rod diameter. In some embodiments, the handle diameter may be significantly greater than the rod diameter. In some embodiments, the handle 236 has a textured exterior surface configured to assist a user's grip of the handle 236. This may assist a user in applying torque to the handle 236, thereby tightening the rod 238 adjacent to the surface 12 on which the device 200 is to be affixed.

In some embodiments, the rod 238 is configured to extend within the C-bracket 224 and reach to the U-shaped surface 232. When the device 200 is not attached to a surface 12, the distal end of the rod 238 may be positioned within a cavity 242 within the U-shaped channel 234 of the clamp 218. The rod 238 may be inserted into the cavity 242 such that the rod 238 remains in an out-of-use position when the device 200 is not attached to a surface.

In some embodiments, the rod 238 may be disposed within the C-bracket 224 when the device 200 is in use such that the distal end of the rod 238 does not reach the cavity 242. In such embodiments, the handle 236 may be rotated, turning the rod 238 and threading the rod 238 away from the U-shaped surface 232, opening a gap between the distal end 238a of the rod 238 and the U-shaped surface 232, thus allowing a surface 12 therebetween. The rod 238 may then be tightened within the C-bracket 224 such that the surface 12 against or upon which the device 200 is to be attached is captured between the distal end 238a of the rod 238 and the U-shaped channel 232. The force applied to the surface 12 between the U-shaped channel 232 and the distal end 238a of the rod 238 maintains and holds securely the position of the device 200 with respect to the surface 12. Alternatively, the surface 12 may be a planar surface such as a tray or countertop. In such embodiments, the rod 238 may capture the surface 12 between the distal end 238a of the rod 238 and the opposing ends of the U-shaped channel 234.

In some embodiments, the faceplate assembly 222 of the device 200 may be further adjusted via the adjustability mechanism 220. In such embodiments, mounting the device 200 using the clamp 218 and adjusting the device using the adjustability mechanism 220 allows the practitioner to change the configuration of the faceplate assembly 222 such that the faceplate assembly 222 may be disposed at various angles and/or positions. The broad and various configurations in which the device 200 may be positioned using the adjustability of the clamp 218 and the adjustability mechanism 220 allows for versatility in use of the device 200 as to where it can be used and the angles at which it can hold containers 14.

As best shown in FIGS. 2A-2D, the faceplate assembly 222 may be rotated relative to the clamp 218 via the adjustability mechanism 220. The adjustability mechanism 220 may include a plurality of rotational assemblies 250a, 250b configured to rotate the faceplate mechanism 222 about a rotational axis. Each rotational assembly 250a, 250b may rotationally move about their respective axes while the clamp 218 remains stably affixed to the surface 12. As best shown in FIGS. 2A-2D, the opening of the clamp 218 faces opposite the faceplate assembly 222, although it should be known that the opening of the clamp 218 may face any direction desirable to the practitioner.

The first rotational assembly 250a may include a variety of features. The first rotational assembly 250a may be operably connected to the clamp 218. The first rotational assembly 250a may rotate about the location at which it is attached to the clamp 218. In some embodiments, the first rotational assembly 250a may rotate 360 degrees about an axis centered around the location at which it is attached to the clamp 218. In other embodiments, the amount of rotation may be restricted to certain angles.

In some embodiments, the movement of the first rotational assembly 250a may be selectively restricted (or “locked”) and unrestricted (or “unlocked”). A first rotational assembly lock 252a may be disposed on the clamp 218. The first rotational assembly lock 252a may be urged to a locked position by default (e.g., by a spring assembly or the like) and may restrict the movement of the first rotational assembly 250a. In such embodiments, when the first rotational assembly lock 252a is depressed by a user, the first rotational assembly 250a moves to an unlocked position and the faceplate assembly 222 may be rotationally positioned about the axis of the first rotational assembly 250a to the desired orientation.

In some embodiments, the device may have a second rotational assembly 250b. In such embodiments, the second rotational assembly 250b may be rotatably connected to the first rotational assembly 250a about a second rotational axis, and operably connected to the faceplate assembly 222. The second rotational assembly 250b may rotate about an axis centered on the location at which it is attached to the first rotational assembly 250a.

The second rotational assembly's 250b movement may be restricted via a second rotational assembly lock 252b. The second rotational assembly lock 252b may be disposed on the first rotational assembly 250a and urged to a locked position by default (e.g., by a spring assembly or the like). When the second rotational assembly lock 252b is depressed by a user, the second rotational assembly 250b moves to an unlocked position and the faceplate 222 may rotate about the second rotational axis about the location at which the second rotational assembly 252b is attached to the first rotational assembly 250a to the desired orientation.

Turning to FIGS. 2E-2J, the faceplate assembly 222 is shown in more detail. In some embodiments, the faceplate assembly 222 may be substantially rectangular in shape when viewed in plan view, and include a base 270, connecting flanges 272A, 272B, and a bottom plate 274. The faceplate assembly 222 securely holds the medical vials in the desired position and orientation for the practitioner.

The base 270 may include a variety of features. For example, some embodiments of the base may include a top channel 281. The top channel 281 may be characterized by a series of indentations 282. The indentations may be any size, shape, and configuration to provide a stable base for the containers. Some embodiments of the device 200 include V-shaped indentations 282. The V-shaped indentations 282 are only one example of the top channel 281 possible for the device 200 in accordance with this disclosure. Other embodiments may include other structures or shapes (e.g., curved, hexagonal, triangular, or any other shape) configured to stably accommodate a medical vial when positioned in the device 200. While the base 270 is shown as a single element with a channel 281, it should be known that the base 270 may comprise two parts coupled and overlayed together to form the base 270 with the channel 281 formed by the plan view difference between the two elements.

The top channel 281 may define a location in the base 270 at which medical vials are to be positioned. The base 270 may include a plurality of holes 276A-276E. Portions of medical vials (e.g., the smallest diameter portion of the medical vials such as the neck between the spout and the body) may be disposed in the holes 276A-276E such that larger diameter portions of the vials on either side of the neck are in contact with the base 270 holding the vials securely in place. The size of each hole 276 may be modified via an adjustable panel 278, as will be discussed in further detail below.

The faceplate assembly 222 may include connecting flanges 272A, 272B, configured to attach the faceplate assembly 222 to the second rotational assembly 250B. Each flange 272A, 272B may be any size, shape and configuration and may include features configured to accommodate one or more connectors from the second rotational assembly 250B. Such features may include first and second connector openings 284A, 284B. The first and second connector openings 284A, 284B may have different shapes. For example, the first connector opening 284A may be round to accommodate various rotational positions and the second connector opening 284B may be a square shape to restrict rotational movement between the faceplate assembly and the second rotational assembly 250B. The shapes of the first and second connector openings 284A, 284B may restrict the movement of the faceplate assembly 222. This may reduce the risk of disturbing the medical vials disposed thereon.

FIG. 2F shows a bottom view of the faceplate assembly 222 including the bottom plate 274. In some embodiments, the bottom plate 274 may include a plurality of openings 290 configured to allow the passage of a mechanical fastener (e.g., a self-tapping screw, a machine screw, or any other mechanical fastener known it the art) therethrough. Such a mechanical fastener may be used to fasten the bottom plate 274 to the base 270, although it should be known that any attachment method known in the art may be used.

In some embodiments, the bottom plate 274 may include a plurality of openings 288A-288E. Openings 288A-288E may be configured to allow the passage of a positioning flange 280A-280E therethrough. The openings 288A may be any size, shape, and configuration (e.g., round, circular, triangular, hexagonal, or any other shape) in order to allow the necessary sliding movement of the positioning flange 280 forward and backward by the practitioner to enlarge and restrict the size of each corresponding opening 276. In some embodiments, the openings 288A-288E may be generally rectangular having a lateral width and a longitudinal width, and the positioning flanges 280A-280E may be generally rectangular having a lateral width substantially similar or slightly smaller than the lateral width of the openings 280 and a longitudinal width substantially smaller than the longitudinal width of the openings 280 to allow for sufficient longitudinal movement of the adjustable panel 278 within the window or opening 276 as explained in more detail below.

As shown in FIGS. 2G-2H, each positioning flange 280 may correspond to an adjustable panel 278. As best shown in FIGS. 21-2J, the positioning flanges 280 may reach downwardly from the bottom plate 274 such that they are easily reachable by the practitioner. Looking back at FIGS. 2G-2H, the positioning flange(s) 280 may be used by the practitioner to manipulate the position of each positioning flange's respective adjustable panel 278. For example, the practitioner may apply a force onto a positioning flange 280, thereby moving the positioning flange 280 and adjustable panel 278. Movement of the adjustable panel 278 may alter the size of the opening within the base holes 276A-276E. Moving the positioning flange 280 away from the holes 276A-276E of the base 270 may increase the size of the opening within holes 276A-276E. Conversely, moving the positioning flange towards the holes of the base may decrease the size of the opening within holes 276A-276E.

In some embodiments, the positioning flange(s) 280 and adjustment panel(s) 278 may be spring-loaded. In such embodiments, the positioning flange 280 may be moved away from the holes 276A-276E by the practitioner to enlarge the size of the hole for vial insertion or removal and subsequently released to return to a position closer to the holes (i.e. making the opening within the holes smaller) 276A-276E. The force provided by the spring-loaded adjustment panel(s) 278 may urge the adjustment panel(s) 278, thereby reducing the size of the holes 276A-276E and provide the securing force necessary for holding the medical vial securely in place.

In use, the practitioner may manipulate the positioning flange 280 such that it is maneuvered in a direction away from the holes 276. This widens the opening within holes 276 by retracting the adjustment panel 278. A user may then place or locate the neck of a medical vial or container into the hole(s). Then, the practitioner may release the positioning flange 280, pinning the neck of the medical vial between the end of the adjustment panel 278 and the end of the hole 276. This may cause the protraction of the adjustable panel 278 and maintain the vial or container in a desired position. The practitioner may then repeat this process within different holes 276 and with different medical vials as many times as necessary. In doing so, the device 200 may hold multiple vials concurrently.

Being able to position multiple medical vials can provide improved efficiency for healthcare providers. The device 200 may allow multiple vials to be ready for use by medical providers, which can reduce the preparation time needed to prepare the vials for use. Further, the device 200 can assist in aspirating the medications by reducing the risk of contaminating the liquid within the container or the bottle itself through human touch and aid in aspirating medication being extracted by a needle. That is, the device 200 can assist in reducing the risk of air in the medication being introduced into a needle or syringe by stabilizing the vial when medication is being extracted from therein.

In still other embodiments, as shown in FIGS. 3A-3D, a hands-free medical stabilization device 300 is substantially similar to the devices 100, 200 as described above except as detailed below. In such embodiments, a device 300 may include a faceplate assembly 322, an adjustability mechanism 320, and a clamp 318.

In some embodiments, the device 300 may hold and/or stabilize containers 14 of varying sizes using at least one adjustable opening on or within a faceplate assembly 322 as detailed below. In such embodiments, the device 300 may hold and/or stabilize containers 14 of varying sizes using at least one adjustable opening on or within a faceplate assembly 322 as detailed below. In some embodiments the device 300 is capable of holding up to five vials 14, although it should be known that the device 300 may be configured to hold any number of containers 14 (e.g., 1, 2, 3, 4, 6, or more containers 14) and in any configuration (e.g., in a line as shown in FIGS. 3A-3C, in a stacked formation, in a circular formation, or in any other formation) without deviating from the scope of the disclosure. When the stabilization device 300 is mounted on a surface 12 via the clamp 318, the device 300 may be manipulated such that the faceplate 322 and the containers 14 held thereon can be disposed at various angles and/or configurations to provide easy access for a practitioner. This allows a user to attach the device 300 at various locations and to various surfaces, including, but not limited to, surfaces found in clinics, procedural rooms, and/or carts.

As best shown in FIG. 3A, the device 300 can be mounted on a surface 12 in a variety of ways. In some embodiments, the device 300 can be mounted to a surface having any orientation (e.g., a pole oriented vertically, a surface oriented horizontally as shown in FIG. 3A, or any other orientation) using the clamp 318. As shown, the clamp may include a C-clamp 324 having upper and lower jaws 324a, 324b and a tightening screw 326. The tightening screw may include a handle 336 that, when turned, opens the upper and lower jaws 324a, 324b to locate the device 300 and close the jaws 324a, 324b to stably hold the device 300 to the surface 12. The clamp 318 may be configured to attach to any surface to which the clamp 318 may be tightened.

Turning to FIGS. 3B-3C, the faceplate assembly 322 is shown in more detail. In some embodiments, the faceplate assembly 322 may be substantially rectangular in shape when viewed in plan view, and include a base 370, a top plate 372, and a bottom plate 374. The faceplate assembly 322 securely holds the medical vials in the desired position and orientation for the practitioner.

The faceplate assembly 322 may include a variety of features. For example, some embodiments of the faceplate 322 may include channels 381 on a top side of the faceplate 322 and on the bottom side of the faceplate 322. The channels 381 may be characterized by a series of indentations 382 formed by differences in plan form of the top plate 372 and the base 370 and between the bottom plate 374 and the base 370. The indentations may be any size, shape, and configuration to provide a stable base for the containers for use on either the top or bottom of the faceplate 322. Some embodiments of the device 300 include V-shaped indentations 382. The V-shaped indentations 382 are only one example of the channels 381 possible for the device 300 in accordance with this disclosure. Other embodiments may include other structures or shapes (e.g., curved, hexagonal, triangular, or any other shape) configured to stably accommodate a medical vial 14 when positioned in the device 300.

The channels 381 may define locations in the faceplate 322 at which medical vials are to be positioned. The base 370 may include a plurality of holes 376A-376E. Portions of medical vials (e.g., the smallest diameter portion of the medical vials such as the neck between the spout and the body) may be disposed in the holes 376A-376E such that larger diameter portions of the vials on either side of the neck are in contact with the base 370 holding the vials securely in place. The size of each hole 376 may be modified via an adjustable panel 378, as will be discussed in further detail below.

In some embodiments, the top plate 372, the bottom plate 374, or both may include a plurality of openings 388. Openings 388 may be configured to allow the passage of a positioning flange 380 therethrough. The openings 388 may be any size, shape, and configuration (e.g., round, circular, triangular, hexagonal, or any other shape) in order to allow the necessary sliding movement of the positioning flange 380 forward and backward by the practitioner to enlarge and restrict the size of each corresponding opening 376. In some embodiments, the openings 388 may be generally rectangular having a lateral width and a longitudinal width, and the positioning flanges 380 may be generally rectangular having a lateral width substantially similar or slightly smaller than the lateral width of the openings 380 and a longitudinal width substantially smaller than the longitudinal width of the openings 380 to allow for sufficient longitudinal movement of the adjustable panel 378 within the window or opening 276 as explained in more detail below.

In certain of such embodiments, each positioning flange 380 may correspond to an adjustable panel 378. As shown in FIG. 3C, the positioning flanges 380 may reach downwardly from the bottom plate 374, and as shown in FIG. 3B, positioning flanges 380 may reach upwardly from the top plate 372 such that they are easily reachable by the practitioner on either side of the faceplate 322. In such embodiments, the positioning flange(s) 380 may be used by the practitioner to manipulate the position of each positioning flange's respective adjustable panel 378. For example, the practitioner may apply a force onto a positioning flange 380, thereby moving the positioning flange 380 and adjustable panel 378. Movement of the adjustable panel 378 may alter the size of the opening within the base holes 376. Moving the positioning flange 380 away from the holes 376 of the base 370 may increase the size of the opening within holes 376. Conversely, moving the positioning flange towards the holes of the base may decrease the size of the opening within holes 376. In some embodiments, a spring (not explicitly shown in the Figures) is located within the faceplate and against the positioning flange 380 such that the positioning flange 380 is urged toward the hole 376 such that the practitioner must force the positioning flange 380 to an open position to insert or remove a vial 14, and may simply release the positioning flange to close the hole 376 or to stably hold the vial 14 in place within faceplate without further practitioner intervention.

In some embodiments, an adjustability mechanism 320 can be located between the faceplate assembly 322 and the clamp 318. In such embodiments, the adjustability mechanism provides the mechanisms necessary for the practitioner to adjust the location and orientation of the faceplate 322, and to stably hold that location and orientation in place. As best shown in FIGS. 3D-3E, in some embodiments, the adjustability mechanism 320 may comprise a rotation T-bar 350 and a rotation beam 352. In such embodiments, the T-bar 350 is fixedly attached to a back (i.e., a side opposite the vial holders) of the faceplate 322. The T-bar 350 can have a base 354, a rotation end 358, and a neck 356 connecting the rotation end 358 to the base 354. The rotation end can have a number of anti-rotation teeth 358a arranged about a lateral axis 358b through the rotation end of the T-bar 350. In some embodiments, the T-bar can include a through-hole 362 in line with the lateral axis 358b.

In some embodiments, the adjustability mechanism further includes a rotation beam 352. The rotation beam 352 may be generally an elongated cuboid in shape, having a clamp connection end 365 and a rotation end 366. The rotation end may include a number of anti-rotation teeth 366a arranged about a lateral axis 366b through the rotation end 366 of the rotation beam 352. The anti-rotation teeth 366a are configured to operably couple with the anti-rotation teeth 358a on the T-bar 350 such that when tightened together, rotational movement between the T-bar 350 and the rotation beam 352 is restricted. As shown in FIGS. 3D-3E, the teeth 358a, 366a are matching triangular teeth radially disposed around the respective axes 358b, 366b, although it should be known that the teeth 358a, 366a can take on any complementary shapes to allow positional rotation when separated, and restrict rotational movement when tightened together.

In some embodiments, the rotation beam 352 can include a through hole 363 in line with the lateral axis 366b. The through hole 363 corresponds to through hole 362 on the T-bar 350 such that a single fastener (e.g., a bolt, a screw, or the like) may be inserted therethrough and tightened to securely hold the T-bar 350 and the rotation beam 352 together to prevent relative movement between the two. In some embodiments, the clamp connect end 365 of the rotation beam 352 may include a hole 368, either threaded or unthreaded (i.e., to accept a self-tapping screw or the like), to receive a clamp fastener such as a bolt 319. In such embodiments, the clamp connection end may further include one or more anti-rotation flange(s) 367 that are positioned against and/or couple with connection edges of the clamp 318 to create an interference between the adjustability mechanism 320 and the clamp 318 to prevent relative rotation.

While the various systems described above are separate implementations, any of the individual components, mechanisms, or devices, and related features and functionality, within the various system embodiments described in detail above may be incorporated into any of the other system embodiments herein.

The term “about,” as used herein, refers to variation in the numerical quantity that may occur, for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The term “about” also encompasses these variations. The term “about” may include any variation of 5% or 10%, or any amount-including any integer-between 0% and 10%. Further, whether or not modified by the term “about,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Although the various embodiments have been described with reference to preferred implementations, persons skilled in the art will recognize that changes may be made in form and detail without departing from the spirit and scope thereof.

What is claimed is:

1. A device for holding a plurality of containers comprising:
(a) a clamp;
(b) a faceplate comprising:
(i) at least one container opening therewithin, the at least one container opening configured to receive a container therewithin; and
(ii) at least one adjustment panel slidably disposed within the at least one container openings, the adjustment panel positionable between:
(A) an open position whereby a container may be received within or removed from the at least one container opening, and
(B) a closed position whereby a container may be securely held in place; and
(c) an adjustment assembly fixable to the clamp on a proximal portion and fixable to the faceplate on a distal portion, the adjustment assembly comprising:
(i) a first component fixable to the faceplate; and
(ii) a second component fixable to the clamp;
wherein the first component and the second component are rotationally positionable with respect to one another.

2. The device of claim 1, wherein the faceplate further comprises a spring operably coupled to the at least one adjustment panel, the spring configured to urge the adjustment panel toward the closed position.

3. The device of claim 1, wherein the at least one adjustment panel further comprises a positioning flange extending through an adjustment opening in the faceplate such that a user is able to adjust the adjustment panels to increase the opening within each of the securing holes.

4. The device of claim 1, wherein the at least one container opening comprises at least four openings.

5. The device of claim 1, wherein the container is a vial containing medical liquid.

6. The device of claim 1, wherein the adjustment assembly further comprises a tightening bolt, and wherein first component and the second component each comprises corresponding teeth that are selectively operably coupled by the tightening bolt.

7. The device of claim 1, wherein the first and second components further comprise locking mechanisms.

8. The device of claim 7, wherein the locking mechanisms of the first and second components are in a locked position by default.

9. The device of claim 8, wherein a user activates an unlock mechanism on at least one of the first and second components to re-orient the faceplate.

10. The device of claim 9, wherein the unlock mechanism is a button that a user depresses.

11. The device of claim 1, wherein the clamp comprises:
(i) a base;
(ii) a holding flange; and
(iii) a locking mechanism.

12. A device for securely holding medicinal containers comprising:
(a) a base comprising:
(i) at least one container opening therewithin, the at least one container opening configured to receive a container therewithin;
(ii) at least one adjustment opening; and
(ii) at least one adjustment panel slidably disposed within the at least one container openings and having an adjustment flange disposed on an end opposite from the container opening and extending through the at least one adjustment opening, the adjustment panel positionable between:
(A) an open position whereby a container may be received within or removed from the at least one container opening, and
(B) a closed position whereby a container may be securely held in place; and
(b) a clamp operably coupled to the base and configured to securely attach to a surface.

13. The device of claim 12, further comprising:
(a) an adjustment assembly fixable to the clamp on a proximal portion and fixable to the faceplate on a distal portion, the adjustment assembly comprising:
(i) a first component fixable to the faceplate; and
(ii) a second component fixable to the clamp;
wherein the first component and the second component are rotationally positionable with respect to one another.

14. The device of claim 13, wherein the adjustment assembly further comprises a tightening bolt, and wherein first component and the second component each comprises corresponding teeth that are selectively operably coupled by the tightening bolt.

15. The device of claim 12, wherein the at least one container opening comprises at least three openings.

16. The device of claim 12, wherein the at least one adjustment panel further comprises a positioning flange extending through an adjustment opening in the faceplate such that a user is able to adjust the adjustment panels to increase the opening within each of the securing holes.

17. The device of claim 12, wherein the clamp is operably coupled to the base on a side opposite from the at least one container opening.

18. A device for holding a plurality of containers comprising:
(a) a clamp configured to operably couple to a surface;
(b) a faceplate comprising:
(i) at least one container opening therewithin, the at least one container opening configured to receive a container therewithin;
(ii) at least one adjustment opening; and
(ii) at least one adjustment panel slidably disposed within the at least one container openings and having an adjustment flange disposed on an end opposite from the container opening and extending through the at least one adjustment opening, the adjustment panel positionable between:
(A) an open position whereby a container may be received within or removed from the at least one container opening, and
(B) a closed position whereby a container may be securely held in place; and
(c) an adjustment assembly fixable to the clamp on a proximal portion and fixable to the faceplate on a distal portion, the adjustment assembly comprising:
(i) a first component fixable to the faceplate; and
(ii) a second component fixable to the clamp;
wherein the first component and the second component are rotationally positionable and lockable with respect to one another.

19. The device of claim 18, wherein the adjustment assembly further comprises a tightening bolt, and wherein first component and the second component each comprises corresponding teeth that are selectively operably coupled by the tightening bolt.

20. The device of claim 18, wherein the faceplate further comprises a spring operably coupled to the at least one adjustment panel, the spring configured to urge the adjustment panel toward the closed position.
